(19) United States
(12) Patent Application Publication
(10) Pub. No.: US 2026/0206062 A1
(43) Pub. Date: Jul. 16, 2026

(54) VALIDITY OF RANDOM ACCESS RESOURCES IN SUBBAND FULL DUPLEX SLOTS

(71) Applicant: QUALCOMM Incorporated, San Diego, CA (US)

(72) Inventors: Ahmed Attia ABOTABL, San Diego, CA (US); Hung Dinh LY, San Diego, CA (US); Muhammad Sayed Khairy ABDELGHAFFAR, San Jose, CA (US)

(21) Appl. No.: 19/025,786

(22) Filed: Jan. 16, 2025

(51) Int. Cl. H04W 74/0833; H04L 5/16

(52) U.S. Cl. CPC H04W 74/0833; H04L 5/16

(57) ABSTRACT

Methods, systems, and devices for wireless communications are described. A user equipment (UE) may receive one or more first control messages indicating a first configuration of a first set of random access occasions associated with transmission of a random access request and may receive one or more second control messages indicating a second configuration of a second set of random access occasions in addition to the first set of random access occasions and associated with transmission of the random access request. The UE may determine the validity of random access occasions of the second set based on whether the random access occasion overlap with subband full duplex slots. The validity of such random access occasions may be dependent on the first configuration, the second configuration, or one or more conditions.

### FIELD OF TECHNOLOGY

The following relates to wireless communications, including validity of random access resources in subband full duplex slots.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications systems may implement techniques to support energy savings. For example, user equipments (UEs) may be configured with or utilize energy savings modes that are associated with reduced transmissions, receptions, or both. Similarly, wireless communications systems may implement techniques for energy savings at the network side.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request, receiving one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages, and transmitting the random access request via at least one valid random access occasion from the first set of random access occasions or the second set of random access occasions.

A UE for wireless communications is described. The UE may include one or more memories storing processor executable code, and one or more processors coupled with the one or more memories. The one or more processors may individually or collectively be operable to execute the code to cause the UE to receive one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request, receive one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages, and transmit the random access request via at least one valid random access occasion from the first set of random access occasions or the second set of random access occasions.

Another UE for wireless communications is described. The UE may include means for receiving one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request, means for receiving one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages, and means for transmitting the random access request via at least one valid random access occasion from the first set of random access occasions or the second set of random access occasions.

A non-transitory computer-readable medium storing code for wireless communications is described. The code may include instructions executable by one or more processors to receive one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request, receive one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages, and transmit the random access request via at least one valid random access occasion from the first set of random access occasions or the second set of random access occasions.

In some examples of the method, user equipment (UEs), and non-transitory computer-readable medium described herein, the first configuration specifies that the first random access occasions may be valid in portions that overlap with half duplex slots and the second random access occasions may be valid in portions that overlap with the half duplex slots in accordance with the first configuration.

In some examples of the method, user equipment (UEs), and non-transitory computer-readable medium described herein, the first random access occasions may be invalid in portions that overlap with subband full duplex slots in accordance with the first configuration and the second random access occasions may be invalid in portions that overlap with the subband full duplex slots in accordance with the first configuration.

In some examples of the method, user equipment (UEs), and non-transitory computer-readable medium described herein, the first configuration specifies that the first random access occasions may be valid in portions that overlap with subband full duplex slots and the second random access occasions of the second set of random access occasions may be valid in portions that overlap with the subband full duplex slots in accordance with the first configuration.

In some examples of the method, user equipment (UEs), and non-transitory computer-readable medium described herein, the first random access occasions may be invalid in portions that overlap with half duplex slots in accordance with the first configuration and the second random access occasions may be invalid in portions that that overlap with the half duplex slots in accordance with the first configuration.

In some examples of the method, user equipment (UEs), and non-transitory computer-readable medium described herein, the first configuration specifies that the first random access occasions may be valid in portions that overlap half duplex slots or subband full duplex slots and the second random access occasions of the second set of random access occasions may be valid in portions that overlap with the half duplex slots or the subband full duplex slots in accordance with the first configuration.

In some examples of the method, user equipment (UEs), and non-transitory computer-readable medium described herein, the second set of random access occasions may be associated with a network energy savings mode.

In some examples of the method, user equipment (UEs), and non-transitory computer-readable medium described herein, the subband full duplex slot includes both uplink and downlink resources.

A method for wireless communications by a UE is described. The method may include receiving one or more first control messages indicating a first configuration of a first set of random access occasions associated with transmission of a random access request, receiving one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request, and transmitting the random access request via at least one valid random access occasion from the first set of random access occasions or the second set of random access occasions.

A UE for wireless communications is described. The UE may include one or more memories storing processor executable code, and one or more processors coupled with the one or more memories. The one or more processors may individually or collectively be operable to execute the code to cause the UE to receive one or more first control messages indicating a first configuration of a first set of random access occasions associated with transmission of a random access request, receive one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request, and transmit the random access request via at least one valid random access occasion from the first set of random access occasions or the second set of random access occasions.

Another UE for wireless communications is described. The UE may include means for receiving one or more first control messages indicating a first configuration of a first set of random access occasions associated with transmission of a random access request, means for receiving one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request, and means for transmitting the random access request via at least one valid random access occasion from the first set of random access occasions or the second set of random access occasions.

A non-transitory computer-readable medium storing code for wireless communications is described. The code may include instructions executable by one or more processors to receive one or more first control messages indicating a first configuration of a first set of random access occasions associated with transmission of a random access request, receive one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request, and transmit the random access request via at least one valid random access occasion from the first set of random access occasions or the second set of random access occasions.

In some examples of the method, user equipment (UEs), and non-transitory computer-readable medium described herein, the second configuration specifies that the second random access occasions may be valid in portions that overlap with half duplex slots.

In some examples of the method, user equipment (UEs), and non-transitory computer-readable medium described herein, the second configuration specifies that the second random access occasions may be valid in portions that overlap with subband full duplex slots and half duplex slots.

In some examples of the method, user equipment (UEs), and non-transitory computer-readable medium described herein, the second configuration specifies that the second random access occasions may be valid in portions that overlap with subband full duplex slots.

In some examples of the method, user equipment (UEs), and non-transitory computer-readable medium described herein, validity of first random access occasions of the first set of random access occasions for transmission of the random access request in accordance with the first configuration may be different from validity of the second random access occasions of the second set of random access occasions in accordance with the second configuration.

In some examples of the method, user equipment (UEs), and non-transitory computer-readable medium described herein, receiving the one or more second control messages may include operations, features, means, or instructions for receiving a semi-static control message, where the semi-static control message includes system information or a radio resource control message.

In some examples of the method, user equipment (UEs), and non-transitory computer-readable medium described herein, receiving the one or more second control messages may include operations, features, means, or instructions for receiving one or more second control messages via a dynamic control message, where the dynamic control message includes a downlink control information message.

In some examples of the method, user equipment (UEs), and non-transitory computer-readable medium described herein, the second set of random access occasions may be associated with a network energy savings mode.

In some examples of the method, user equipment (UEs), and non-transitory computer-readable medium described herein, the subband full duplex slot includes both uplink and downlink resources.

A method for wireless communications by a UE is described. The method may include receiving one or more first control messages indicating a first configuration of a first set of random access occasions associated with transmission of a random access request, receiving one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both, and transmitting the random access request via at least one valid random access occasion from the first set of random access occasions or the second set of random access occasions.

A UE for wireless communications is described. The UE may include one or more memories storing processor executable code, and one or more processors coupled with the one or more memories. The one or more processors may individually or collectively be operable to execute the code to cause the UE to receive one or more first control messages indicating a first configuration of a first set of random access occasions associated with transmission of a random access request, receive one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both, and transmit the random access request via at least one valid random access occasion from the first set of random access occasions or the second set of random access occasions.

Another UE for wireless communications is described. The UE may include means for receiving one or more first control messages indicating a first configuration of a first set of random access occasions associated with transmission of a random access request, means for receiving one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both, and means for transmitting the random access request via at least one valid random access occasion from the first set of random access occasions or the second set of random access occasions.

A non-transitory computer-readable medium storing code for wireless communications is described. The code may include instructions executable by one or more processors to receive one or more first control messages indicating a first configuration of a first set of random access occasions associated with transmission of a random access request, receive one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both, and transmit the random access request via at least one valid random access occasion from the first set of random access occasions or the second set of random access occasions.

In some examples of the method, user equipment (UEs), and non-transitory computer-readable medium described herein, the one or more conditions include a periodicity of the first set of random access occasions, the second set of random access occasions, or both and whether the second random access occasions may be valid in portions that overlap with subband full duplex slots may be based on the periodicity.

In some examples of the method, user equipment (UEs), and non-transitory computer-readable medium described herein, whether the second random access occasions may be valid in portions that overlap with the subband full duplex slots may be based on the periodicity relative to a threshold periodicity.

In some examples of the method, user equipment (UEs), and non-transitory computer-readable medium described herein, the second configuration indicates a duration during which the second set of random access occasions may be valid, the one or more conditions include the duration and, and whether the second random access occasions may be valid in portions that overlap with subband full duplex slots may be based on the duration.

In some examples of the method, user equipment (UEs), and non-transitory computer-readable medium described herein, whether the second random access occasions may be valid in portions that overlap with the subband full duplex slots may be based on the duration relative to a threshold duration.

In some examples of the method, user equipment (UEs), and non-transitory computer-readable medium described herein, receiving the one or more second control messages may include operations, features, means, or instructions for receiving a signal that activates the second configuration of the second set of random access occasions, where the one or more conditions include a signal type of the signal, where whether the second random access occasions may be valid in portions that overlap with the subband full duplex slot may be based on the signal type of the signal that activates the second configuration.

In some examples of the method, user equipment (UEs), and non-transitory computer-readable medium described herein, the one or more conditions include an objective of the random access request and whether the second random access occasions may be valid in portions that overlap with the subband full duplex slot may be based on the objective.

In some examples of the method, user equipment (UEs), and non-transitory computer-readable medium described herein, the objective includes a beam failure recovery or a mobility random access procedure.

In some examples of the method, user equipment (UEs), and non-transitory computer-readable medium described herein, the second set of random access occasions may be associated with a network energy savings mode.

In some examples of the method, user equipment (UEs), and non-transitory computer-readable medium described herein, the subband full duplex slot includes both uplink and downlink resources.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports validity of random access resources in subband full duplex slots in accordance with one or more aspects of the present disclosure.

FIG. 2 shows an example of a wireless communications system that supports validity of random access resources in subband full duplex slots in accordance with one or more aspects of the present disclosure.

FIG. 3 shows an example of a process flow that supports validity of random access resources in subband full duplex slots in accordance with one or more aspects of the present disclosure.

FIGS. 4 and 5 show block diagrams of devices that support validity of random access resources in subband full duplex slots in accordance with one or more aspects of the present disclosure.

FIG. 6 shows a block diagram of a communications manager that supports validity of random access resources in subband full duplex slots in accordance with one or more aspects of the present disclosure.

FIG. 7 shows a diagram of a system including a device that supports validity of random access resources in subband full duplex slots in accordance with one or more aspects of the present disclosure.

FIGS. 8 through 10 show flowcharts illustrating methods that support validity of random access resources in subband full duplex slots in accordance with one or more aspects of the present disclosure.

### DETAILED DESCRIPTION

Wireless communications systems may implement techniques to support energy savings. For example, user equipments (UEs) may be configured with or utilize energy savings modes that are associated with reduced transmissions, receptions, or both. Similarly, wireless communications systems may implement techniques for energy savings at the network side. Some wireless communications systems may support dynamic adaptation of random access resources (physical random access channel (PRACH) occasions) for network energy savings. For example, a UE may be configured with an initial (legacy) set of random access occasions via which the UE may transmit a random access request, and an additional dynamic set of random access occasions may be activated at the UE, and the UE may use the legacy or additional occasions to transmit the random access request. The initial set of random access occasions may be sparse such as to reduce the frequency at which the network entity is to wake up to monitor the occasions. The additional occasions may be distributed between or among the sparse occasions and may be dynamically activated based on network conditions.

Additionally, in some cases, random access occasions (e.g., legacy occasions) may be valid only when they overlap with half duplex slots (e.g., slots where data can be communicated in a single direction at a time, such as uplink or downlink). That is, because random access occasions are used for uplink transmissions (e.g., random access requests), the random access occasions may be required to overlap with uplink resources (e.g., slots dedicated for uplink or flexible) for the random access occasions to be valid for use in transmitting random access requests. However, some slots may be subband full duplex slots that include uplink and downlink resources in different frequency subbands of the slot. In such cases, validity of the legacy occasions that overlap with the subband full duplex slots may be dependent on a configuration indicated by the network. That is, the network may indicate whether the random access occasions that overlap with subband full duplex slots are valid for transmission of random access requests. In some cases, the validity of such occasions are dependent on (additionally or alternatively) the capability of the UE to communicate via subband full duplex slots (e.g., Rel. 19+ UEs may be able to use subband full duplex slots). Currently, there are limited techniques (if any) to determine whether the dynamically indicated (additional) random access occasions that overlap with subband full duplex slots are also valid for transmission of a random access request.

Techniques described herein support indications of whether the dynamically indicated (additional) random access occasions are valid when such occasions overlap with subband full duplex slots. In accordance with a first proposal, the configuration for the additional RACH occasions follow the configuration for the legacy RACH occasions. Thus, if the legacy occasions are valid on subband full duplex slots, then the additional occasions are also valid on subband full duplex slots. In accordance with a second proposal, the validity of the additional occasions are separately configured. In accordance with a third proposal, the validity of the additional occasions is dependent on a condition, such as a periodicity of the legacy or additional occasions relative to a threshold, a duration during which the additional occasions are activated relative to a threshold, the signaling used to activate the additional occasions, or purpose of the RACH configuration (e.g., beam failure recovery, initial access). These and other techniques are described in further detail with respect to the figures.

Aspects of the disclosure are initially described in the context of wireless communications systems. Aspects of the disclosure are further described with respect to a wireless communications system implementing subband full duplex slots and a process flow. Aspects of the disclosure are further illustrated by and described with reference to apparatus diagrams, system diagrams, and flowcharts that relate to validity of random access resources in subband full duplex slots.

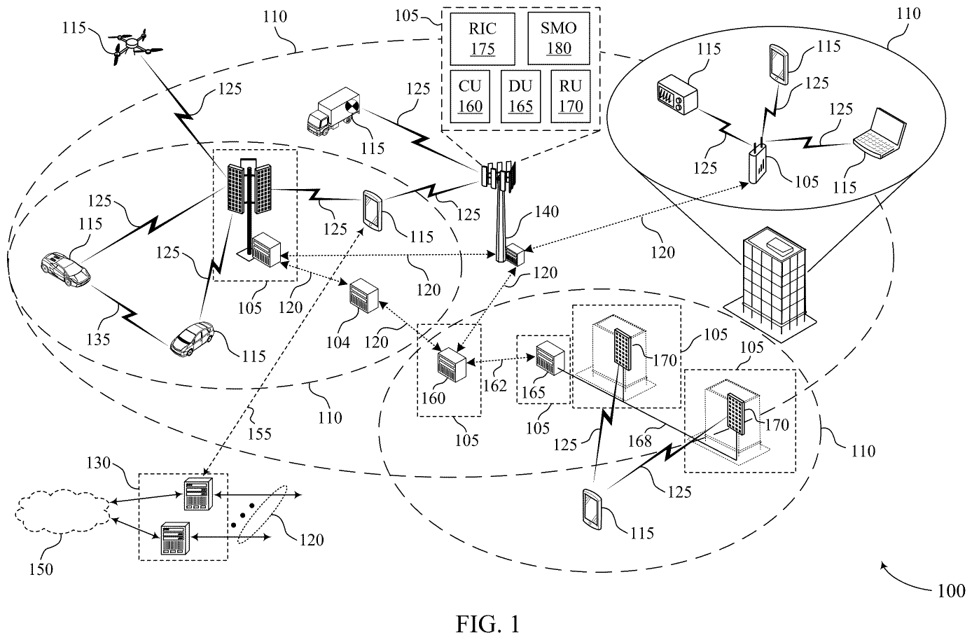

FIG. 1 shows an example of a wireless communications system 100 that supports validity of random access resources in subband full duplex slots in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support validity of random access resources in subband full duplex slots as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may implement techniques to support energy savings. For example, the UEs 115 may be configured with or utilize energy savings modes that are associated with reduced transmissions, receptions, or both. Similarly, wireless communications systems may implement techniques for energy savings at the network side. Some wireless communications systems may support dynamic adaptation of random access resources (physical random access channel (PRACH) occasions) for network energy savings. For example, a UE 115 may be configured with an initial (legacy) set of random access occasions via which the UE 115 may transmit a random access request, and an additional dynamic set of random access occasions may be activated at the UE 115. In such cases, the UE 115 may use the legacy or additional occasions to transmit the random access request. The initial set of random access occasions may be sparse such as to reduce the frequency at which the network entity 105 is to wake up to monitor the occasions. The additional occasions may be distributed between or among the sparse occasions and may be dynamically activated based on network conditions.

Additionally, in some cases, random access occasions (e.g., legacy occasions) may be valid only when they overlap with half duplex (e.g., uplink or flexible) slots. That is, because random access occasions are used for uplink transmissions (e.g., random access requests), the random access occasions may be required to overlap with uplink resources (e.g., in uplink or flexible slots) for the random access occasions to be valid for use in transmitting random access requests. However, some slots may be subband full duplex slots that include uplink and downlink resources. In such cases, validity of the legacy occasions that overlap with the subband full duplex slots may be dependent on a configuration indicated by the network entity 105. That is, the network entity 105 may indicate whether the random access occasions that overlap with subband full duplex slots are valid for transmission of random access requests. In some cases, the validity of such occasions additionally, or alternatively, dependent on the capability of the UE 115 to communicate via subband full duplex slots (e.g., Rel. +19 UEs may be able to use subband full duplex slots). Currently, there are limited techniques (if any) to determine whether the dynamically indicated (additional) random access occasions that overlap with subband full duplex slots are also valid for transmission of a random access request.

Techniques described herein support indications of whether the dynamically indicated (additional) random access occasions are valid when such occasions overlap with subband full duplex slots. In accordance with a first proposal, the additional occasions follow the configuration for the legacy slots. Thus, if the legacy occasions are valid on subband full duplex slots, then the additional occasions are also valid on subband full duplex slots. In accordance with a second proposal, the validity of the additional occasions are separately configured. In accordance with a third proposal, the validity of the additional occasions are dependent on a condition, such as a periodicity of the legacy or additional occasions relative to a threshold, a duration during which the additional occasions are activated relative to a threshold, the signaling used to activate the additional occasions, or purpose of the RACH configuration (e.g., beam failure recovery, initial access).

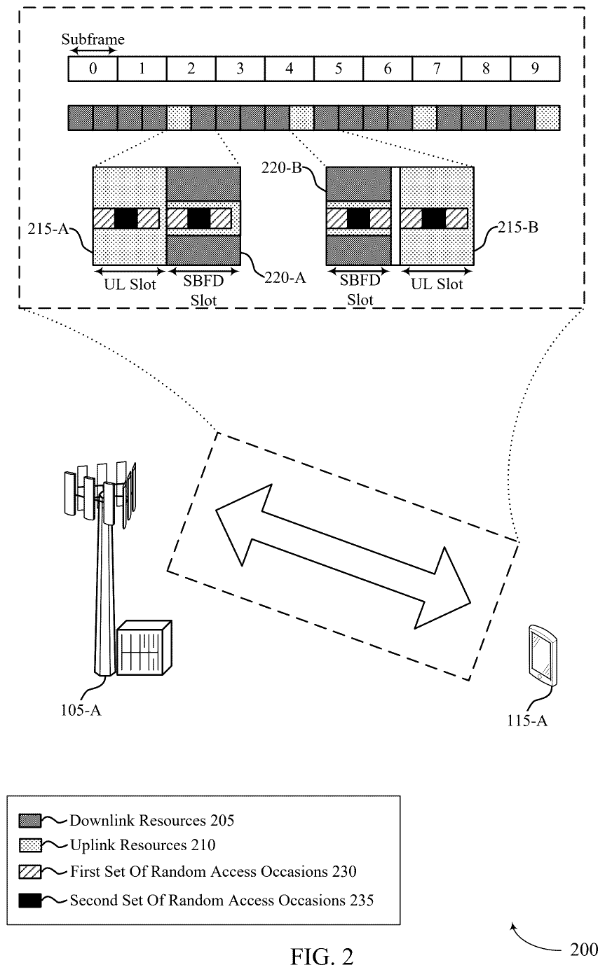

FIG. 2 shows an example of a wireless communications system 200 that supports validity of random access resources in subband full duplex slots in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 described herein.

The UE 115 may be configured to utilize uplink slots 215-a and 215-b and subband full duplex slots 220-a and 220-b, in addition to other types of slots (e.g., downlink or flexible slots). The UE 115-a may be a UE 115 which is capable communications via subband full duplex slots 220, which include both downlink resources and uplink resources 210. For example, the subband full duplex slots 220 may include uplink resources 210, which the UE 115-a may use to transmit uplink signaling to the network entity 105-a, and the downlink resources may be used by the network entity 105-a to communicate with the UE 115-a and/or other UEs 115.

The network entity 105-a may configure a first set of random access occasions 230, which may be examples of legacy random access occasions. In some communication systems, a random access occasion (sometimes abbreviated as RACH occasion or RO) may be an example of designated communication resources (e.g., time resources and frequency resources) where the network listens for PRACH preambles transmitted by UEs. A legacy random access occasion may be an example of statically or semi-statically configured RACH occasions. An additional random access occasion may be an example of a dynamically schedulable random access occasion that occurs in addition to a legacy random access occasion. The first set of random access occasions 230 may be configured via system information (e.g., system information block 2 (SIB2)), and the system information may be indicative of the time domain configuration, frequency domain configuration, format, etc. of the random access occasions across a set of slots. Additionally, the network entity 105-a may configure a second set of random access occasions 235, which may be examples of additional or dynamically activated random access occasions. As described herein, the first set of random access occasions 230 may be active and sparsely configured relative to when both sets of random access occasions are active. The sparse configuration may support network energy savings by reducing or limiting the frequency at which the network entity 105-a wakes up to monitor the first set of random access occasions 230. However, the network entity 105-a may activate the second set of random access occasions 235 based on various conditions, such as an increase in communication traffic, to allow UEs 115 to efficiently use the random access occasions to establish a connection. Thus, after the second set of random access occasions 235 are activated, random access occasions of either the first set of random access occasions 230 or the second set of random access occasions 235 may be used for random access requests, depending on other factors. The second set of random access occasions 235 may be configured using various techniques, such as changing the periodicity of the legacy occasions (e.g., the first set of random access occasions 230), providing another (separate) PRACH configuration index, etc. For example, if the UE 115-a is provided a separate PRACH configuration index, the UE may derive the union of the legacy random access occasions (the first set of random access occasions 230) and the additional random access occasions (e.g., the second set of random access occasions 235).

As illustrated in FIG. 2, some of the first set of random access occasions 230 may fall within (e.g., overlap with) the uplink slots 215. As described herein, subband full duplex random access occasions may be configured or introduced by either 1) enabling the legacy configuration to have valid occasions in the subband full duplex slots 220; or 2) having a separate configuration for subband full duplex random access occasions. The random access occasions of the first set of random access occasions 230, which overlap with subband full duplex slots 220, may be valid for transmission of random access requests. However, other random access occasions of the first set of random access occasions 230 may fall within (e.g., overlap with) the subband full duplex slots. In some cases, depending on the network configuration, or other factors, the random access occasions of the first set of random access occasions that fall within the subband full duplex slots may be “invalid,” and may not be used for transmission of random access requests. Alternatively, these random access occasions of the first set of random access occasions 230 that fall within the subband slots may be valid (e.g., if such occasions overlap with the uplink resources 210 of the subband full duplex slots 220) for transmission of the random access requests, depending on a configuration or other factors. However, the UE 115-a may be unable to determine whether random access occasions of the second set of random access occasions 235 that overlap with the subband full duplex slots 220 are valid for transmission of random access requests.

Techniques described herein support the UE 115-a in determining whether the second set of random access occasions 235 that overlap with subband full duplex slots 220 are valid for transmission of random access requests. In accordance with a first option, the additional random access occasions (e.g., the second set of random access occasions 235) may follow the configuration for the first set of random access occasions 230. Thus, if the configuration for the first set of random access occasions 230 is that such occasions are invalid (for transmission of random access requests) when the occasions overlap with subband full duplex slots 220, then the random access occasions of the second set of random access occasions 235 that overlap with the subband full duplex slots 220 are also invalid (for transmission of random access requests). Similarly, if the configuration for the first set of random access occasions 230 is that such occasions are valid (for transmission of random access requests) when the occasions overlap with subband full duplex slots 220, then the random access occasions of the second set of random access occasions 235 that overlap with the subband full duplex slots 220 are also valid (for transmission of random access requests). The configuration for the first set of random access occasions 230 may specify that the occasions are valid for legacy slots only (e.g., half duplex slots, such as uplink slots 215 or flexible slots), subband full duplex slots only, or valid for both legacy and subband full duplex slots. In this first option, the validity of the second set of random access occasions 235 may follow the configuration for the first set of random access occasions 230.

As described herein, the configuration may specify whether the first set of random access occasions 230 that overlap with subband full duplex slots are valid or not (only half-duplex slots), and in accordance with this first option, the second set of random access occasions 235 may follow the configuration. Additionally, the first set of random access occasions 230 may have separate configurations for legacy random access occasions (only overlapping with half-duplex slots) and for random access occasions that overlap with subband full duplex slots. If separate configurations are used, then the additional second set of random access occasions 235 may be valid only in the subband full duplex slots 220.

In accordance with a second option for providing or determining the validity of the second set of random access occasions 235, the second set of random access occasions 235 may be associated with a separate configuration from the first set of random access occasions 230. Thus, the separate configuration for the second set of random access occasions 235 may specify that the second set of random access occasions 235 are valid in the half-duplex/legacy slots only, valid in both half-duplex and subband full duplex slots, or subband full duplex slots only. Thus, the UE 115-a may follow the separate configuration for the second set of random access occasions 235 for determining the validity of such occasions. The separate configuration for the second set of random access occasions 235 may be indicated either semi-statically (e.g., system information block 1 (SIB1) or RRC signaling) or dynamically indicated. In the case of dynamic indication, an activation DCI may indicate the separate configuration. In case of DCI signaling, the configuration may be indicated via prior signaling, such as RRC, then activated via the DCI.

In accordance with a third option for providing or determining the validity of the second set of random access occasions 235, the validity may be based on one or more conditions. For example, whether the second set of random access occasions 235 that overlap with subband full duplex slots are valid or not may be dependent on a periodicity of the first set of random access occasions 230, the second set of random access occasions 235, or both. In some cases, the UE 115-a may compare one or more of the periodicities to a threshold, which may be configured by the network entity 105-a. For example, if the periodicity is greater than the threshold, then the occasions of the second set of random access occasions that overlap with subband full duplex slots are invalid (e.g., due to being enough occasions due to the high periodicity). Similarly, if the periodicity is less than the threshold, then the occasions of the second set of random access occasions that overlap with subband full duplex slots are valid.

Another condition that may be indicative of the validity of the second set of random access occasions 235 may be a duration of the timeline during which the second set of random access occasions 235 are activated. For example, if the timeline is long (e.g., greater than a configured threshold), then the random access occasions of the second set of random access occasions 235 that overlap with the subband full duplex slots may be valid. Similarly, if the timeline is short (e.g., less than the threshold), then the then the random access occasions of the second set of random access occasions 235 that overlap with the subband full duplex slots may be invalid.

Another condition that may be indicative of the validity of the second set of random access occasions 235 may be the signaling, method, or technique used for configuring or activating the second set of random access occasions 235. In such cases, different types of signals may be mapped to different behaviors. For example, if the second set of random access occasions are activated via DCI, then the then the random access occasions of the second set of random access occasions 235 that overlap with the subband full duplex slots are valid. Similarly, if the second set of random access occasions are activated via RRC or PDCCH ordered RACH, then the then the random access occasions of the second set of random access occasions 235 that overlap with the subband full duplex slots are invalid. Other signaling techniques and behavior mappings are contemplated within the scope of the present disclosures.

Another condition that may be indicative of the validity of the second set of random access occasions 235 may be the purpose of the PRACH configuration. For example, a dedicated PRACH configuration for beam failure recovery (BFR) may only allow the second set of random access occasions 235 (additional random access occasions) to be valid in half-duplex slots, while a PRACH configuration for mobility may allow the second set of random access occasions to be valid in half-duplex and subband full duplex slots.

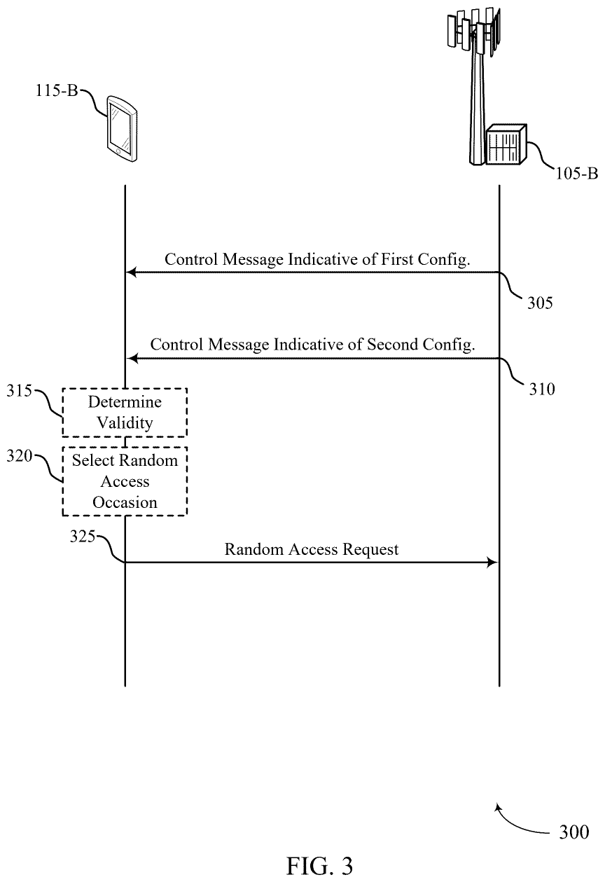

FIG. 3 shows an example of a process flow 300 that supports validity of random access resources in subband full duplex slots in accordance with one or more aspects of the present disclosure. The process flow 300 may implement aspects of a wireless communications system 100 and a wireless communications system 200 described herein. For example, the process flow 300 may be implemented by a UE 115-b and a network entity 105-b, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

In a first implementation of the process flow, at 305, the UE 115-b may receive, from the network entity 105-b, one or more first control messages indicating a first configuration of a first set of random access occasions associated with transmission of a random access request. The first configuration specifies whether first random access occasions of the first set of random access occasions that at least partially overlap with a subband full duplex slot are valid for transmission of the random access request.

At 310, the UE 115-b may receive, from the network entity 105-b, one or more second control messages indicating a second configuration of a second set of random access occasions in addition to the first set of random access occasions and associated with transmission of the random access request. In such cases, whether second random access occasions of the second set of random access occasions that at least partially overlap with the subband full duplex slot are valid for transmission of the random access request is in accordance with the first configuration of the one or more first control messages.

At 315, the UE 115-b may determine the validity of the second set of random access occasions that overlap with the subband full duplex slot based on the first configuration of the first set of random access occasions. In one or more first examples, the first configuration specifies that the first random access occasions are valid in portions that overlap with half duplex slots, and the second random access occasions are valid in portions that overlap with the half duplex slots in accordance with the first configuration. In such examples, the first random access occasions are invalid in portions that overlap with subband full duplex slots in accordance with the first configuration, and the second random access occasions are invalid in portions that overlap with the subband full duplex slots in accordance with the first configuration.

In one or more second examples, the first configuration specifies that the first random access occasions are valid in portions that overlap with subband full duplex slots, and the second random access occasions of the second set of random access occasions are valid in portions that overlap with the subband full duplex slots in accordance with the first configuration. In such examples, the first random access occasions are invalid in portions that overlap with half duplex slots in accordance with the first configuration, and the second random access occasions are invalid in portions that that overlap with the half duplex slots in accordance with the first configuration. In one or more third examples, the first configuration specifies that the first random access occasions are valid in portions that overlap half duplex slots or subband full duplex slots, and the second random access occasions of the second set of random access occasions are valid in portions that overlap with the half duplex slots or the subband full duplex slots in accordance with the first configuration.

At 320, the UE 115-b may select one or more random access occasions for transmission of the random access request from valid occasions from either the first set or the second set. At 325, the UE 115-b may transmit, to the network entity 105-b, the random access request (e.g., preamble) via at least one valid random access occasion from the first set of random access occasions or the second set of random access occasions.

In a second implementation of the process flow, at 305, the UE 115-b may receive, from the network entity 105-b, one or more first control messages indicating a first configuration of a first set of random access occasions associated with transmission of a random access request.

At 310, the UE 115-b may receive, from the network entity 105-b, one or more second control messages indicating a second configuration of a second set of random access occasions in addition to the first set of random access occasions and associated with transmission of the random access request. In such cases, the second configuration is indicative of whether second random access occasions of the second set of random access occasions that at least partially overlap with a subband full duplex slot are valid for transmission of the random access request.

At 315, the UE 115-b may determine the validity of the second set of random access occasions that overlap with the subband full duplex slot based on the second configuration of the second set of random access occasions. In one or more first examples, the second configuration specifies that the second random access occasions are valid in portions that overlap with half duplex slots. In one or more second examples, the second configuration specifies that the second random access occasions are valid in portions that overlap with subband full duplex slots and half duplex slots. In one or more third examples, the second configuration specifies that the second random access occasions are valid in portions that overlap with subband full duplex slots.

The UE 115-a may also determine the validity of the first set of random access occasion for transmission of the random access request. For example, validity of first random access occasions of the first set of random access occasions for transmission of the random access request in accordance with the first configuration is different from validity of the second random access occasions of the second set of random access occasions in accordance with the second configuration.

At 320, the UE 115-b may select one or more random access occasions for transmission of the random access request from valid occasions from either the first set or the second set. At 325, the UE 115-b may transmit, to the network entity 105-b, the random access request via at least one valid random access occasion from the first set of random access occasions or the second set of random access occasions.

In a third implementation of the process flow, at 305, the UE 115-b may receive, from the network entity 105-b, one or more first control messages indicating a first configuration of a first set of random access occasions associated with transmission of a random access request.

At 310, the UE 115-b may receive, from the network entity 105-b, one or more second control messages indicating a second configuration of a second set of random access occasions in addition to the first set of random access occasions and associated with transmission of the random access request. In such cases, whether second random access occasions of the second set of random access occasions that overlap with a subband full duplex slot are valid for transmission of the random access request is based on one or more conditions associated with the first set of random access occasions, the second set of random access occasions, or both.

At 315, the UE 115-b may determine the validity of the second set of random access occasions that overlap with the subband full duplex slot based on the one or more conditions. In one or more first examples, the one or more conditions include a periodicity of the first set of random access occasions, the second set of random access occasions, or both, and whether the second random access occasions are valid in portions that overlap with subband full duplex slots is based on the periodicity. In such cases, whether the second random access occasions are valid in portions that overlap with the subband full duplex slots may be based on the periodicity relative to a threshold periodicity. In one or more second examples, the second configuration indicates a duration during which the second set of random access occasions is valid, and the one or more conditions include the duration. In such cases, wherein whether the second random access occasions are valid in portions that overlap with subband full duplex slots is based on the duration. Additionally, whether the second random access occasions are valid in portions that overlap with the subband full duplex slots is based on the duration relative to a threshold duration.

In one or more third examples, the one or more second control signals may activate the second configuration of the second set of random access occasions, and the one or more conditions include a signal type of the signal. In such cases, whether the second random access occasions are valid in portions that overlap with the subband full duplex slot is based on the signal type (e.g., paging DCI or PDCCH ordered RACH) of the signal that activates the second configuration.

In one or more third options, the one or more conditions may include an objective of the random access request, and whether the second random access occasions are valid in portions that overlap with the subband full duplex slot is based on the objective. The objective may be a BFR or mobility random access procedure.

At 320, the UE 115-b may select one or more random access occasions for transmission of the random access request from valid occasions from either the first set or the second set. At 325, the UE 115-b may transmit, to the network entity 105-b, the random access request via at least one valid random access occasion from the first set of random access occasions or the second set of random access occasions.

In the above examples of the implementation of the process flow 300, the second set of random access occasions may be associated with a network energy savings mode. Additionally, the subband full duplex slots may include both uplink and downlink resources. The one or more second control messages may include semi-static control signaling, such as system information or RRC signaling. In another examples, the one or more second control messages may include a dynamic control message, such as a downlink control information message. Additionally, the “portions” described herein may be portions of the random access occasions that overlap with uplink resources, such as uplink resources 210 of FIG. 2. In some examples, the occasions may be invalid if any portion overlaps with a downlink resource, such as downlink resources 205 of FIG. 2.

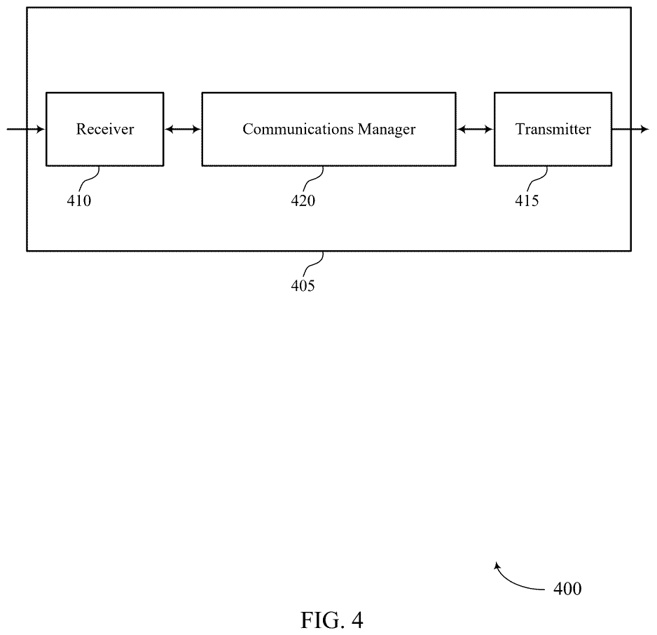

FIG. 4 shows a block diagram 400 of a device 405 that supports validity of random access resources in subband full duplex slots in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to validity of random access resources in subband full duplex slots). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to determining validity of random access resources in subband full duplex slots). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of determining validity of random access resources in subband full duplex slots as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request. The communications manager 420 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages. The communications manager 420 is capable of, configured to, or operable to support a means for transmitting the random access request via at least one valid random access occasion from the first set of random access occasions or the second set of random access occasions.

Additionally, or alternatively, the communications manager 420 may support wireless communications in accordance with examples as disclosed herein. For example, the communications manager 420 is capable of, configured to, or operable to support a means for receiving one or more first control messages indicating a first configuration of a first set of random access occasions associated with transmission of a random access request. The communications manager 420 is capable of, configured to, or operable to support a means for receiving one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request. The communications manager 420 is capable of, configured to, or operable to support a means for transmitting the random access request via at least one valid random access occasion from the first set of random access occasions or the second set of random access occasions.

Additionally, or alternatively, the communications manager 420 may support wireless communications in accordance with examples as disclosed herein. For example, the communications manager 420 is capable of, configured to, or operable to support a means for receiving one or more first control messages indicating a first configuration of a first set of random access occasions associated with transmission of a random access request. The communications manager 420 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both. The communications manager 420 is capable of, configured to, or operable to support a means for transmitting the random access request via at least one valid random access occasion from the first set of random access occasions or the second set of random access occasions.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources and reduced power consumption by allowing dynamic configuration of random access occasions.

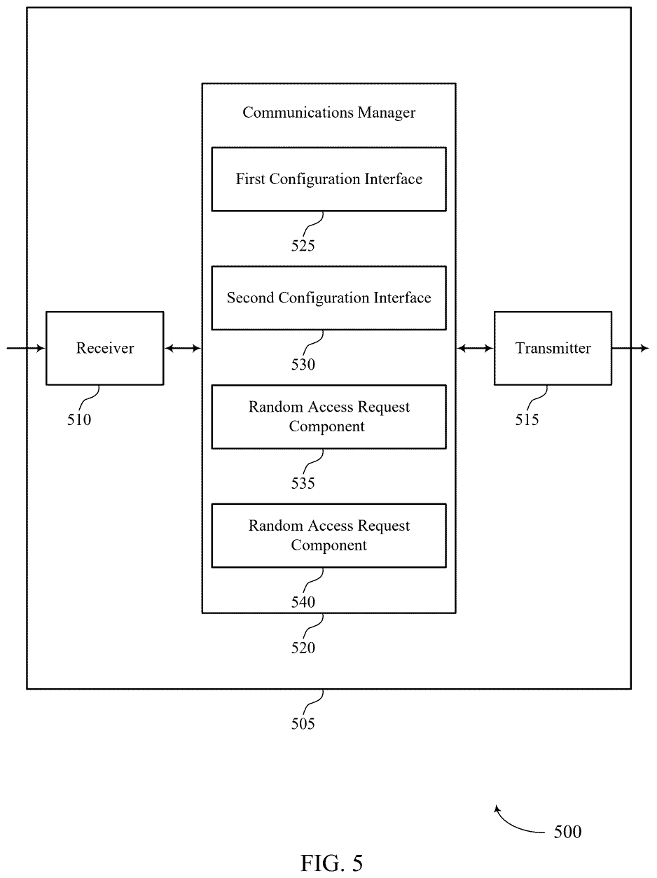

FIG. 5 shows a block diagram 500 of a device 505 that supports validity of random access resources in subband full duplex slots in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to determining validity of random access resources in subband full duplex slots). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to determining validity of random access resources in subband full duplex slots). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of determining validity of random access resources in subband full duplex slots as described herein. For example, the communications manager 520 may include a first configuration interface 525, a second configuration interface 530, a random access request component 535, a random access request component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The first configuration interface 525 is capable of, configured to, or operable to support a means for receiving one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request. The second configuration interface 530 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages. The random access request component 535 is capable of, configured to, or operable to support a means for transmitting the random access request via at least one valid random access occasion from the first set of random access occasions or the second set of random access occasions.

Additionally, or alternatively, the communications manager 520 may support wireless communications in accordance with examples as disclosed herein. The first configuration interface 525 is capable of, configured to, or operable to support a means for receiving one or more first control messages indicating a first configuration of a first set of random access occasions associated with transmission of a random access request. The second configuration interface 530 is capable of, configured to, or operable to support a means for receiving one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request. The random access request component 540 is capable of, configured to, or operable to support a means for transmitting the random access request via at least one valid random access occasion from the first set of random access occasions or the second set of random access occasions.

Additionally, or alternatively, the communications manager 520 may support wireless communications in accordance with examples as disclosed herein. The first configuration interface 525 is capable of, configured to, or operable to support a means for receiving one or more first control messages indicating a first configuration of a first set of random access occasions associated with transmission of a random access request. The second configuration interface 530 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both. The random access request component 540 is capable of, configured to, or operable to support a means for transmitting the random access request via at least one valid random access occasion from the first set of random access occasions or the second set of random access occasions.

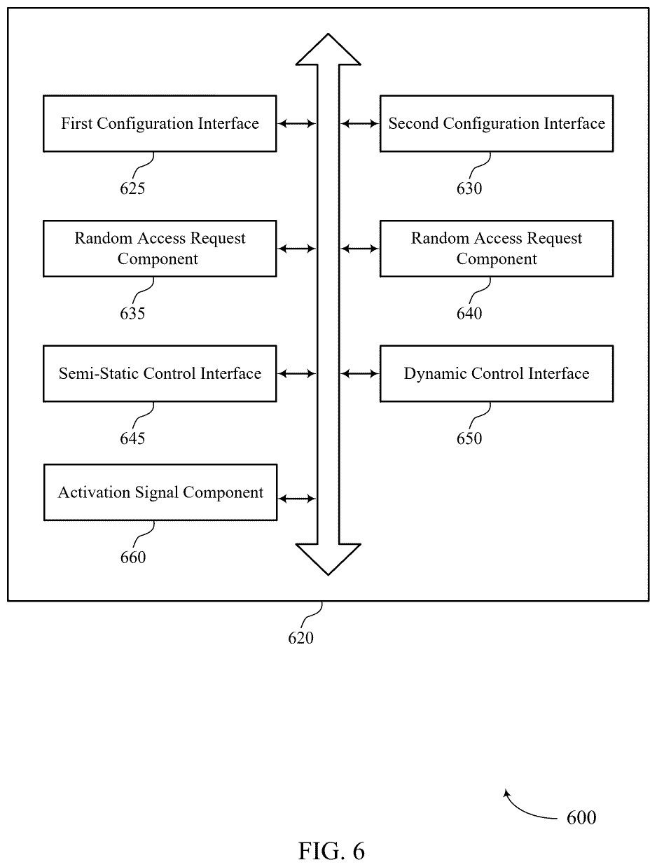

FIG. 6 shows a block diagram 600 of a communications manager 620 that supports validity of random access resources in subband full duplex slots in accordance with one or more aspects of the present disclosure. The communications manager 620 may be an example of aspects of a communications manager 420, a communications manager 520, or both, as described herein. The communications manager 620, or various components thereof, may be an example of means for performing various aspects of determining validity of random access resources in subband full duplex slots as described herein. For example, the communications manager 620 may include a first configuration interface 625, a second configuration interface 630, a random access request component 635, a random access request component 640, a semi-static control interface 645, a dynamic control interface 650, an activation signal component 660, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The first configuration interface 625 is capable of, configured to, or operable to support a means for receiving one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request. The second configuration interface 630 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages. The random access request component 635 is capable of, configured to, or operable to support a means for transmitting the random access request via at least one valid random access occasion from the first set of random access occasions or the second set of random access occasions.

In some examples, the first configuration specifies that the first random access occasions are valid in portions that overlap with half duplex slots. In some examples, the second random access occasions are valid in portions that overlap with the half duplex slots in accordance with the first configuration.

In some examples, the first random access occasions are invalid in portions that overlap with subband full duplex slots in accordance with the first configuration. In some examples, the second random access occasions are invalid in portions that overlap with the subband full duplex slots in accordance with the first configuration.

In some examples, the first configuration specifies that the first random access occasions are valid in portions that overlap with subband full duplex slots. In some examples, the second random access occasions of the second set of random access occasions are valid in portions that overlap with the subband full duplex slots in accordance with the first configuration.

In some examples, the first random access occasions are invalid in portions that overlap with half duplex slots in accordance with the first configuration. In some examples, the second random access occasions are invalid in portions that that overlap with the half duplex slots in accordance with the first configuration.

In some examples, the first configuration specifies that the first random access occasions are valid in portions that overlap half duplex slots or subband full duplex slots. In some examples, the second random access occasions of the second set of random access occasions are valid in portions that overlap with the half duplex slots or the subband full duplex slots in accordance with the first configuration.

In some examples, the second set of random access occasions are associated with a network energy savings mode.

In some examples, the subband full duplex slot includes both uplink and downlink resources.

Additionally, or alternatively, the communications manager 620 may support wireless communications in accordance with examples as disclosed herein. In some examples, the first configuration interface 625 is capable of, configured to, or operable to support a means for receiving one or more first control messages indicating a first configuration of a first set of random access occasions associated with transmission of a random access request. In some examples, the second configuration interface 630 is capable of, configured to, or operable to support a means for receiving one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request. The random access request component 640 is capable of, configured to, or operable to support a means for transmitting the random access request via at least one valid random access occasion from the first set of random access occasions or the second set of random access occasions.

In some examples, the second configuration specifies that the second random access occasions are valid in portions that overlap with half duplex slots.

In some examples, the second configuration specifies that the second random access occasions are valid in portions that overlap with subband full duplex slots and half duplex slots.

In some examples, the second configuration specifies that the second random access occasions are valid in portions that overlap with subband full duplex slots.

In some examples, validity of first random access occasions of the first set of random access occasions for transmission of the random access request in accordance with the first configuration is different from validity of the second random access occasions of the second set of random access occasions in accordance with the second configuration.

In some examples, to support receiving the one or more second control messages, the semi-static control interface 645 is capable of, configured to, or operable to support a means for receiving a semi-static control message, where the semi-static control message includes system information or a radio resource control message.

In some examples, to support receiving the one or more second control messages, the dynamic control interface 650 is capable of, configured to, or operable to support a means for receiving one or more second control messages via a dynamic control message, where the dynamic control message includes a downlink control information message.

In some examples, the second set of random access occasions are associated with a network energy savings mode.

In some examples, the subband full duplex slot includes both uplink and downlink resources.

Additionally, or alternatively, the communications manager 620 may support wireless communications in accordance with examples as disclosed herein. In some examples, the first configuration interface 625 is capable of, configured to, or operable to support a means for receiving one or more first control messages indicating a first configuration of a first set of random access occasions associated with transmission of a random access request. In some examples, the second configuration interface 630 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both. In some examples, the random access request component 640 is capable of, configured to, or operable to support a means for transmitting the random access request via at least one valid random access occasion from the first set of random access occasions or the second set of random access occasions.

In some examples, the one or more conditions include a periodicity of the first set of random access occasions, the second set of random access occasions, or both. In some examples, whether the second random access occasions are valid in portions that overlap with subband full duplex slots is based on the periodicity.

In some examples, whether the second random access occasions are valid in portions that overlap with the subband full duplex slots is based on the periodicity relative to a threshold periodicity.

In some examples, the second configuration indicates a duration during which the second set of random access occasions is valid. In some examples, the one or more conditions include the duration and. In some examples, whether the second random access occasions are valid in portions that overlap with subband full duplex slots is based on the duration.

In some examples, whether the second random access occasions are valid in portions that overlap with the subband full duplex slots is based on the duration relative to a threshold duration.

In some examples, to support receiving the one or more second control messages, the activation signal component 660 is capable of, configured to, or operable to support a means for receiving a signal that activates the second configuration of the second set of random access occasions, where the one or more conditions include a signal type of the signal, where whether the second random access occasions are valid in portions that overlap with the subband full duplex slot is based on the signal type of the signal that activates the second configuration.

In some examples, the one or more conditions include an objective of the random access request. In some examples, whether the second random access occasions are valid in portions that overlap with the subband full duplex slot is based on the objective.

In some examples, the objective includes a beam failure recovery or a mobility random access procedure.

In some examples, the second set of random access occasions are associated with a network energy savings mode.

In some examples, the subband full duplex slot includes both uplink and downlink resources.

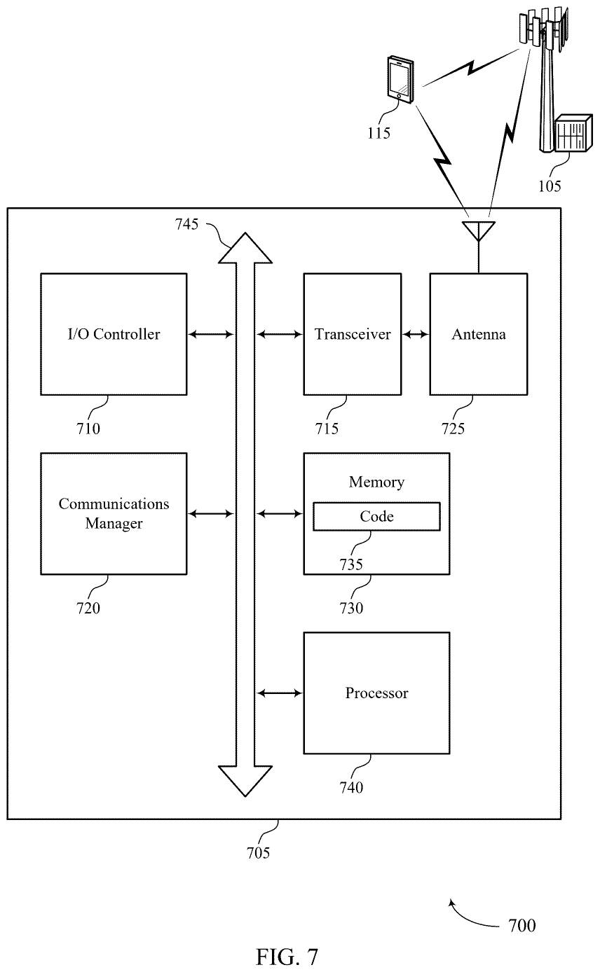

FIG. 7 shows a diagram of a system 700 including a device 705 that supports validity of random access resources in subband full duplex slots in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting determining validity of random access resources in subband full duplex slots). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request. The communications manager 720 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages. The communications manager 720 is capable of, configured to, or operable to support a means for transmitting the random access request via at least one valid random access occasion from the first set of random access occasions or the second set of random access occasions.

Additionally, or alternatively, the communications manager 720 may support wireless communications in accordance with examples as disclosed herein. For example, the communications manager 720 is capable of, configured to, or operable to support a means for receiving one or more first control messages indicating a first configuration of a first set of random access occasions associated with transmission of a random access request. The communications manager 720 is capable of, configured to, or operable to support a means for receiving one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request. The communications manager 720 is capable of, configured to, or operable to support a means for transmitting the random access request via at least one valid random access occasion from the first set of random access occasions or the second set of random access occasions.

Additionally, or alternatively, the communications manager 720 may support wireless communications in accordance with examples as disclosed herein. For example, the communications manager 720 is capable of, configured to, or operable to support a means for receiving one or more first control messages indicating a first configuration of a first set of random access occasions associated with transmission of a random access request. The communications manager 720 is capable of, configured to, or operable to support a means for receiving one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both. The communications manager 720 is capable of, configured to, or operable to support a means for transmitting the random access request via at least one valid random access occasion from the first set of random access occasions or the second set of random access occasions.

By including or configuring the communications manager 720 in accordance with examples as described herein, the device 705 may support techniques for more efficient utilization of communication resources and reduced power consumption by allowing dynamic configuration of random access occasions.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of determining validity of random access resources in subband full duplex slots as described herein, or the at least one processor 740 and the at least one memory 730 may be otherwise configured to, individually or collectively, perform or support such operations.

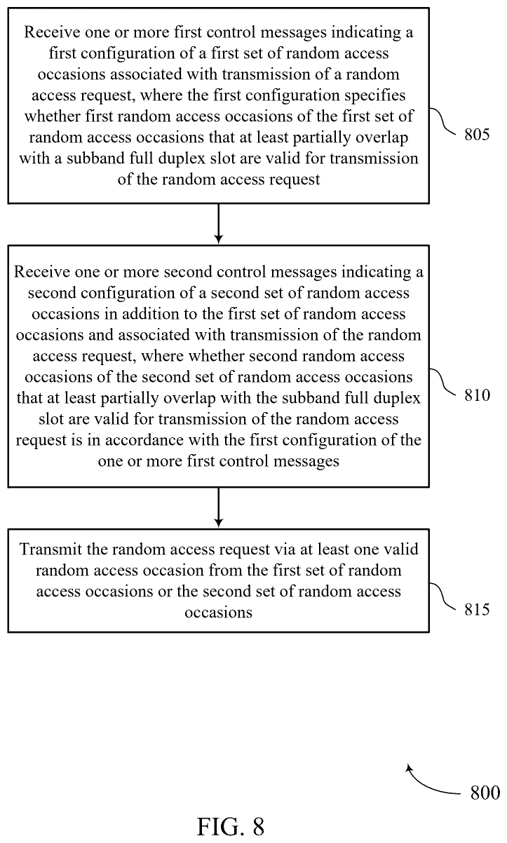

FIG. 8 shows a flowchart illustrating a method 800 that supports validity of random access resources in subband full duplex slots in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving one or more first control messages indicating a first configuration of a first set of random access occasions associated with transmission of a random access request, where the first configuration specifies whether first random access occasions of the first set of random access occasions that at least partially overlap with a subband full duplex slot are valid for transmission of the random access request. The operations of 805 may be performed in accordance with examples as disclosed herein. In some examples, aspects of the operations of 805 may be performed by a first configuration interface 625 as described with reference to FIG. 6.

At 810, the method may include receiving one or more second control messages indicating a second configuration of a second set of random access occasions in addition to the first set of random access occasions and associated with transmission of the random access request, where whether second random access occasions of the second set of random access occasions that at least partially overlap with the subband full duplex slot are valid for transmission of the random access request is in accordance with the first configuration of the one or more first control messages. The operations of 810 may be performed in accordance with examples as disclosed herein. In some examples, aspects of the operations of 810 may be performed by a second configuration interface 630 as described with reference to FIG. 6.

At 815, the method may include transmitting the random access request via at least one valid random access occasion from the first set of random access occasions or the second set of random access occasions. The operations of 815 may be performed in accordance with examples as disclosed herein. In some examples, aspects of the operations of 815 may be performed by a random access request component 635 as described with reference to FIG. 6.

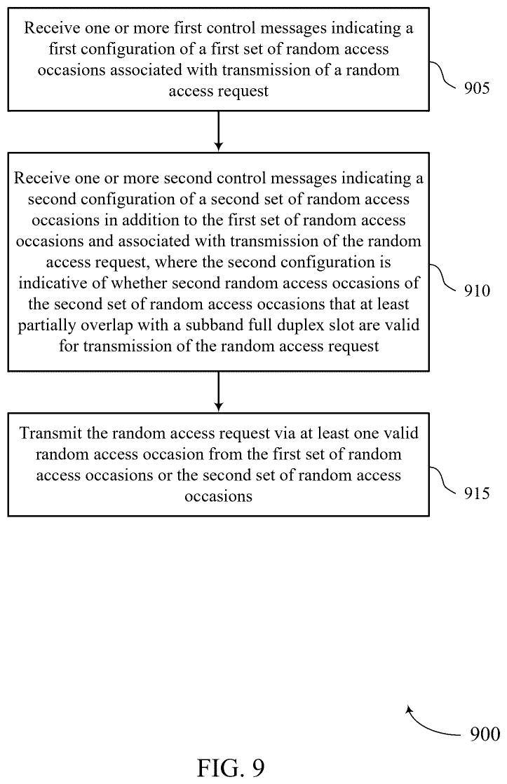

FIG. 9 shows a flowchart illustrating a method 900 that supports validity of random access resources in subband full duplex slots in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving one or more first control messages indicating a first configuration of a first set of random access occasions associated with transmission of a random access request. The operations of 905 may be performed in accordance with examples as disclosed herein. In some examples, aspects of the operations of 905 may be performed by a first configuration interface 625 as described with reference to FIG. 6.

At 910, the method may include receiving one or more second control messages indicating a second configuration of a second set of random access occasions in addition to the first set of random access occasions and associated with transmission of the random access request, where the second configuration is indicative of whether second random access occasions of the second set of random access occasions that at least partially overlap with a subband full duplex slot are valid for transmission of the random access request. The operations of 910 may be performed in accordance with examples as disclosed herein. In some examples, aspects of the operations of 910 may be performed by a second configuration interface 630 as described with reference to FIG. 6.

At 915, the method may include transmitting the random access request via at least one valid random access occasion from the first set of random access occasions or the second set of random access occasions. The operations of 915 may be performed in accordance with examples as disclosed herein. In some examples, aspects of the operations of 915 may be performed by a random access request component 640 as described with reference to FIG. 6.

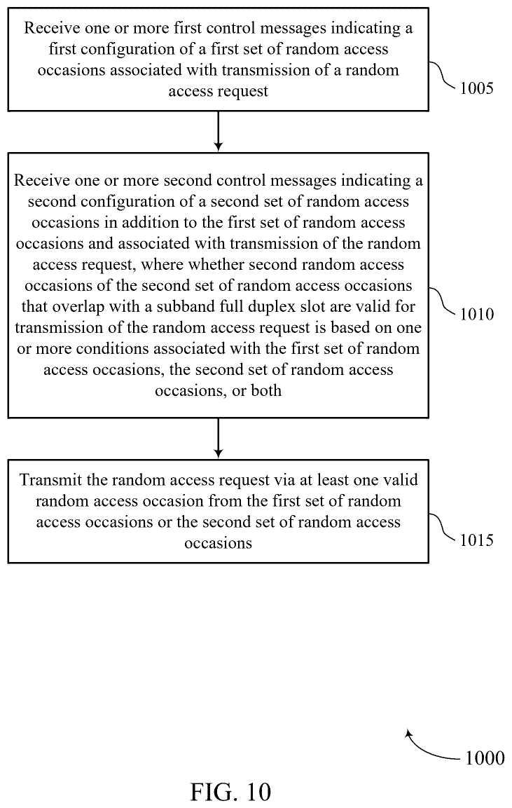

FIG. 10 shows a flowchart illustrating a method 1000 that supports validity of random access resources in subband full duplex slots in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving one or more first control messages indicating a first configuration of a first set of random access occasions associated with transmission of a random access request. The operations of 1005 may be performed in accordance with examples as disclosed herein. In some examples, aspects of the operations of 1005 may be performed by a first configuration interface 625 as described with reference to FIG. 6.

At 1010, the method may include receiving one or more second control messages indicating a second configuration of a second set of random access occasions in addition to the first set of random access occasions and associated with transmission of the random access request, where whether second random access occasions of the second set of random access occasions that overlap with a subband full duplex slot are valid for transmission of the random access request is based on one or more conditions associated with the first set of random access occasions, the second set of random access occasions, or both. The operations of 1010 may be performed in accordance with examples as disclosed herein. In some examples, aspects of the operations of 1010 may be performed by a second configuration interface 630 as described with reference to FIG. 6.

At 1015, the method may include transmitting the random access request via at least one valid random access occasion from the first set of random access occasions or the second set of random access occasions. The operations of 1015 may be performed in accordance with examples as disclosed herein. In some examples, aspects of the operations of 1015 may be performed by a random access request component 640 as described with reference to FIG. 6.

The following provides an overview of aspects of the present disclosure:

Aspect 1: A method for wireless communications at a UE, comprising: receiving one or more first control messages indicating a first configuration of a first set of random access occasions associated with transmission of a random access request, wherein the first configuration specifies whether first random access occasions of the first set of random access occasions that at least partially overlap with a subband full duplex slot are valid for transmission of the random access request; receiving one or more second control messages indicating a second configuration of a second set of random access occasions in addition to the first set of random access occasions and associated with transmission of the random access request, wherein whether second random access occasions of the second set of random access occasions that at least partially overlap with the subband full duplex slot are valid for transmission of the random access request is in accordance with the first configuration of the one or more first control messages; and transmitting the random access request via at least one valid random access occasion from the first set of random access occasions or the second set of random access occasions.

Aspect 2: The method of aspect 1, wherein the first configuration specifies that the first random access occasions are valid in portions that overlap with half duplex slots, the second random access occasions are valid in portions that overlap with the half duplex slots in accordance with the first configuration.

Aspect 3: The method of aspect 2, wherein the first random access occasions are invalid in portions that overlap with subband full duplex slots in accordance with the first configuration, and the second random access occasions are invalid in portions that overlap with the subband full duplex slots in accordance with the first configuration.

Aspect 4: The method of aspect 1, wherein the first configuration specifies that the first random access occasions are valid in portions that overlap with subband full duplex slots, the second random access occasions of the second set of random access occasions are valid in portions that overlap with the subband full duplex slots in accordance with the first configuration.

Aspect 5: The method of aspect 4, wherein the first random access occasions are invalid in portions that overlap with half duplex slots in accordance with the first configuration; and the second random access occasions are invalid in portions that that overlap with the half duplex slots in accordance with the first configuration.

Aspect 6: The method of aspect 1, wherein the first configuration specifies that the first random access occasions are valid in portions that overlap half duplex slots or subband full duplex slots, the second random access occasions of the second set of random access occasions are valid in portions that overlap with the half duplex slots or the subband full duplex slots in accordance with the first configuration.

Aspect 7: The method of any of aspects 1 through 6, wherein the second set of random access occasions are associated with a network energy savings mode.

Aspect 8: The method of any of aspects 1 through 7, wherein the subband full duplex slot comprises both uplink and downlink resources.

Aspect 9: A method for wireless communications at a UE, comprising: receiving one or more first control messages indicating a first configuration of a first set of random access occasions associated with transmission of a random access request; receiving one or more second control messages indicating a second configuration of a second set of random access occasions in addition to the first set of random access occasions and associated with transmission of the random access request, wherein the second configuration is indicative of whether second random access occasions of the second set of random access occasions that at least partially overlap with a subband full duplex slot are valid for transmission of the random access request; and transmitting the random access request via at least one valid random access occasion from the first set of random access occasions or the second set of random access occasions.

Aspect 10: The method of aspect 9, wherein the second configuration specifies that the second random access occasions are valid in portions that overlap with half duplex slots.

Aspect 11: The method of aspect 9, wherein the second configuration specifies that the second random access occasions are valid in portions that overlap with subband full duplex slots and half duplex slots.

Aspect 12: The method of aspect 9, wherein the second configuration specifies that the second random access occasions are valid in portions that overlap with subband full duplex slots.

Aspect 13: The method of any of aspects 9 through 12, wherein validity of first random access occasions of the first set of random access occasions for transmission of the random access request in accordance with the first configuration is different from validity of the second random access occasions of the second set of random access occasions in accordance with the second configuration.

Aspect 14: The method of any of aspects 9 through 13, wherein receiving the one or more second control messages comprises: receiving a semi-static control message, wherein the semi-static control message comprises system information or a radio resource control message.

Aspect 15: The method of any of aspects 9 through 14, wherein receiving the one or more second control messages comprises: receiving one or more second control messages via a dynamic control message, wherein the dynamic control message comprises a downlink control information message.

Aspect 16: The method of any of aspects 9 through 15, wherein the second set of random access occasions are associated with a network energy savings mode.

Aspect 17: The method of any of aspects 9 through 16, wherein the subband full duplex slot comprises both uplink and downlink resources.

Aspect 18: A method for wireless communications at a UE, comprising: receiving one or more first control messages indicating a first configuration of a first set of random access occasions associated with transmission of a random access request; receiving one or more second control messages indicating a second configuration of a second set of random access occasions in addition to the first set of random access occasions and associated with transmission of the random access request, wherein whether second random access occasions of the second set of random access occasions that overlap with a subband full duplex slot are valid for transmission of the random access request is based at least in part on one or more conditions associated with the first set of random access occasions, the second set of random access occasions, or both; and transmitting the random access request via at least one valid random access occasion from the first set of random access occasions or the second set of random access occasions.

Aspect 19: The method of aspect 18, wherein the one or more conditions comprise a periodicity of the first set of random access occasions, the second set of random access occasions, or both, and whether the second random access occasions are valid in portions that overlap with subband full duplex slots is based at least in part on the periodicity.

Aspect 20: The method of aspect 19, wherein whether the second random access occasions are valid in portions that overlap with the subband full duplex slots is based at least in part on the periodicity relative to a threshold periodicity.

Aspect 21: The method of any of aspects 18 through 20, wherein the second configuration indicates a duration during which the second set of random access occasions is valid, the one or more conditions comprise the duration and whether the second random access occasions are valid in portions that overlap with subband full duplex slots is based at least in part on the duration.

Aspect 22: The method of aspect 21, wherein whether the second random access occasions are valid in portions that overlap with the subband full duplex slots is based at least in part on the duration relative to a threshold duration.

Aspect 23: The method of any of aspects 18 through 22, wherein receiving the one or more second control messages comprises: receiving a signal that activates the second configuration of the second set of random access occasions, wherein the one or more conditions comprise a signal type of the signal, wherein whether the second random access occasions are valid in portions that overlap with the subband full duplex slot is based at least in part on the signal type of the signal that activates the second configuration.

Aspect 24: The method of any of aspects 18 through 23, wherein the one or more conditions comprise an objective of the random access request, whether the second random access occasions are valid in portions that overlap with the subband full duplex slot is based at least in part on the objective.

Aspect 25: The method of aspect 24, wherein the objective comprises a beam failure recovery or a mobility random access procedure.

Aspect 26: The method of any of aspects 18 through 25, wherein the second set of random access occasions are associated with a network energy savings mode.

Aspect 27: The method of any of aspects 18 through 26, wherein the subband full duplex slot comprises both uplink and downlink resources.

Aspect 28: A UE for wireless communications, comprising one or more memories storing processor-executable code, and one or more processors coupled with the one or more memories and individually or collectively operable to execute the code to cause the UE to perform a method of any of aspects 1 through 8.

Aspect 29: A UE for wireless communications, comprising at least one means for performing a method of any of aspects 1 through 8.

Aspect 30: A non-transitory computer-readable medium storing code for wireless communications, the code comprising instructions executable by one or more processors to perform a method of any of aspects 1 through 8.

Aspect 31: A UE for wireless communications, comprising one or more memories storing processor-executable code, and one or more processors coupled with the one or more memories and individually or collectively operable to execute the code to cause the UE to perform a method of any of aspects 9 through 17.

Aspect 32: A UE for wireless communications, comprising at least one means for performing a method of any of aspects 9 through 17.

Aspect 33: A non-transitory computer-readable medium storing code for wireless communications, the code comprising instructions executable by one or more processors to perform a method of any of aspects 9 through 17.

Aspect 34: A UE for wireless communications, comprising one or more memories storing processor-executable code, and one or more processors coupled with the one or more memories and individually or collectively operable to execute the code to cause the UE to perform a method of any of aspects 18 through 27.

Aspect 35: A UE for wireless communications, comprising at least one means for performing a method of any of aspects 18 through 27.

Aspect 36: A non-transitory computer-readable medium storing code for wireless communications, the code comprising instructions executable by one or more processors to perform a method of any of aspects 18 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving one or more first control messages indicating a first configuration of a first set of random access occasions associated with transmission of a random access request, wherein the first configuration specifies whether first random access occasions of the first set of random access occasions that at least partially overlap with a subband full duplex slot are valid for transmission of the random access request;
receiving one or more second control messages indicating a second configuration of a second set of random access occasions in addition to the first set of random access occasions and associated with transmission of the random access request, wherein whether second random access occasions of the second set of random access occasions that at least partially overlap with the subband full duplex slot are valid for transmission of the random access request is in accordance with the first configuration of the one or more first control messages; and
transmitting the random access request via at least one valid random access occasion from the first set of random access occasions or the second set of random access occasions.

2. The method of claim 1, wherein:
the first configuration specifies that the first random access occasions are valid in portions that overlap with half duplex slots, and
the second random access occasions are valid in portions that overlap with the half duplex slots in accordance with the first configuration.

3. The method of claim 2, wherein:
the first random access occasions are invalid in portions that overlap with subband full duplex slots in accordance with the first configuration, and
the second random access occasions are invalid in portions that overlap with the subband full duplex slots in accordance with the first configuration.

4. The method of claim 1, wherein:
the first configuration specifies that the first random access occasions are valid in portions that overlap with subband full duplex slots, and
the second random access occasions of the second set of random access occasions are valid in portions that overlap with the subband full duplex slots in accordance with the first configuration.

5. The method of claim 4, wherein:
the first random access occasions are invalid in portions that overlap with half duplex slots in accordance with the first configuration; and
the second random access occasions are invalid in portions that that overlap with the half duplex slots in accordance with the first configuration.

6. The method of claim 1, wherein:
the first configuration specifies that the first random access occasions are valid in portions that overlap half duplex slots or subband full duplex slots, and
the second random access occasions of the second set of random access occasions are valid in portions that overlap with the half duplex slots or the subband full duplex slots in accordance with the first configuration.

7. A method for wireless communications at a user equipment (UE), comprising:
receiving one or more first control messages indicating a first configuration of a first set of random access occasions associated with transmission of a random access request;
receiving one or more second control messages indicating a second configuration of a second set of random access occasions in addition to the first set of random access occasions and associated with transmission of the random access request, wherein the second configuration is indicative of whether second random access occasions of the second set of random access occasions that at least partially overlap with a subband full duplex slot are valid for transmission of the random access request; and
transmitting the random access request via at least one valid random access occasion from the first set of random access occasions or the second set of random access occasions.

8. The method of claim 7, wherein the second configuration specifies that the second random access occasions are valid in portions that overlap with half duplex slots.

9. The method of claim 7, wherein the second configuration specifies that the second random access occasions are valid in portions that overlap with subband full duplex slots and half duplex slots.

10. The method of claim 7, wherein the second configuration specifies that the second random access occasions are valid in portions that overlap with subband full duplex slots.

11. The method of claim 7, wherein validity of first random access occasions of the first set of random access occasions for transmission of the random access request in accordance with the first configuration is different from validity of the second random access occasions of the second set of random access occasions in accordance with the second configuration.

12. The method of claim 7, wherein receiving the one or more second control messages comprises:
receiving a semi-static control message or a dynamic control message, wherein the semi-static control message comprises system information or a radio resource control message, and wherein the dynamic control message comprises a downlink control information message.

13. A method for wireless communications at a user equipment (UE), comprising:
receiving one or more first control messages indicating a first configuration of a first set of random access occasions associated with transmission of a random access request;
receiving one or more second control messages indicating a second configuration of a second set of random access occasions in addition to the first set of random access occasions and associated with transmission of the random access request, wherein whether second random access occasions of the second set of random access occasions that overlap with a subband full duplex slot are valid for transmission of the random access request is based at least in part on one or more conditions associated with the first set of random access occasions, the second set of random access occasions, or both; and
transmitting the random access request via at least one valid random access occasion from the first set of random access occasions or the second set of random access occasions.

14. The method of claim 13, wherein:
the one or more conditions comprise a periodicity of the first set of random access occasions, the second set of random access occasions, or both, and
whether the second random access occasions are valid in portions that overlap with subband full duplex slots is based at least in part on the periodicity.

15. The method of claim 14, wherein whether the second random access occasions are valid in portions that overlap with the subband full duplex slots is based at least in part on the periodicity relative to a threshold periodicity.

16. The method of claim 13, wherein:
the second configuration indicates a duration during which the second set of random access occasions is valid,
the one or more conditions comprise the duration, and
whether the second random access occasions are valid in portions that overlap with subband full duplex slots is based at least in part on the duration.

17. The method of claim 16, wherein whether the second random access occasions are valid in portions that overlap with the subband full duplex slots is based at least in part on the duration relative to a threshold duration.

18. The method of claim 13, wherein receiving the one or more second control messages comprises:
receiving a signal that activates the second configuration of the second set of random access occasions, wherein the one or more conditions comprise a signal type of the signal, wherein whether the second random access occasions are valid in portions that overlap with the subband full duplex slot is based at least in part on the signal type of the signal that activates the second configuration.

19. The method of claim 13, wherein:
the one or more conditions comprise an objective of the random access request, and
whether the second random access occasions are valid in portions that overlap with the subband full duplex slot is based at least in part on the objective.

20. The method of claim 19, wherein the objective comprises a beam failure recovery or a mobility random access procedure.
